(19) United States
(12) Patent Application Publication
(10) Pub. No.: US 2025/0095937 A1
(43) Pub. Date: Mar. 20, 2025

(54) ELECTROMAGNETIC CONTACTOR

(71) Applicant: FUJI ELECTRIC CO., LTD., Kawasaki-shi (JP)

(72) Inventors: Yuma KUSANO, Kounosu-city (JP); Takashi TSUTSUMI, Kounosu-city (JP); Yuya SAKURAI, Kounosu-city (JP); Koujun KONISHI, Kounosu-city (JP)

(73) Assignee: FUJI ELECTRIC CO., LTD., Kawasaki-shi (JP)

(21) Appl. No.: 18/782,364

(22) Filed: Jul. 24, 2024

(30) Foreign Application Priority Data
Sep. 15, 2023 (JP) 2023-150339

(51) Int. Cl. H01H 50/02; H01H 50/38; H01H 50/54

(52) U.S. Cl. CPC H01H 50/023; H01H 50/38; H01H 50/546; H01H 2050/025

(57) ABSTRACT

An electromagnetic contactor includes: a box-shaped arc extinguishing wall which is arranged in a housing and in which a pair of fixed contacts and a movable contact are arranged; first and second arc extinguishing spaces provided on one side and the other side of the movable contact in its longitudinal direction, the first and second arc extinguishing spaces being spaces surrounded by the arc extinguishing wall; a pair of arc extinguishing permanent magnets arranged to face each other and configured to extend a first arc generated between the first fixed contact point and the first movable contact point in the first arc extinguishing space and to extend a second arc generated between the second fixed contact point and the second movable contact point in the second arc extinguishing space; a first opening provided in a wall portion of the arc extinguishing wall which wall portion is on a side toward which the first arc is extended; and a second opening provided in a wall portion of the arc extinguishing wall which wall portion is on a side toward which the second arc is extended.

### TECHNICAL FIELD

The present invention relates to an electromagnetic contactor for opening and closing a current path.

### BACKGROUND ART

An electromagnetic contactor in PATENT DOCUMENT 1, for example, includes a pair of fixed contacts each having a fixed contact point, a movable contact having a pair of movable contact points that can come into contact with and separate from the fixed contact points of the pair of fixed contacts, a contact point case in which the pair of fixed contacts and the movable contact are arranged, an electromagnet unit connected to the movable contact via a drive shaft, and an arc extinguishing permanent magnet configured to extend an arc generated between the fixed contact point and the movable contact point in the contact point case.

In the electromagnetic contactor in PATENT DOCUMENT 1, when arcs are generated between the pair of fixed contact points and the pair of movable contact points at the time when the current path is cut off, the magnetic flux of the arc extinguishing permanent magnet crosses the arcs, so that the arcs to which Lorentz forces are applied due to the Fleming's left-hand rule are extended inside the contact point case and extinguished.

### CITATION LIST

### Patent Literature

PATENT DOCUMENT 1: JP 5629106 B2

### SUMMARY OF INVENTION

### Technical Problem

In the meantime, in the electromagnetic contactor in PATENT DOCUMENT 1, when an arc is generated at the time when heavy current is cut off, the fixed contact point and the movable contact point melt, so that a lot of metal vapor stays in the contact point case. The pressure of the metal vapor might increase locally to cause an air flow of the metal vapor acting in a direction to push back the arc in a reverse direction with respect to a direction where the arc is extended, which might decrease arc extinguishing performance.

In view of this, an object of the present invention is to provide an electromagnetic contactor that can prevent arc extinguishing performance from decreasing even when a lot of metal vapor is generated at the time when heavy current is cut off.

### Solution to Problem

In order to achieve the above object, an electromagnetic contactor according to one aspect of the invention comprises: a pair of fixed contacts having first and second fixed contact points; a movable contact having first and second movable contact points at opposite ends in a longitudinal direction of the movable contact, the first and second movable contact points being able to come into contact with and separate from the first and second fixed contact points; an electromagnet unit configured to drive the movable contact; a housing configured to house the pair of fixed contacts, the movable contact, and the electromagnet unit; a box-shaped arc extinguishing wall having a first opening and a second opening and arranged in the housing so as to contain the pair of fixed contacts and the movable contact; and a pair of arc extinguishing permanent magnets arranged to face each other and configured to extend a first arc generated between the first fixed contact point and the first movable contact point toward a first arc extinguishing space and to extend a second arc generated between the second fixed contact point and the second movable contact point toward a second arc extinguishing space. The first arc extinguishing space and the second arc extinguishing spaces are formed on one side and the other side of the movable contact in the longitudinal direction so as to be surrounded by the arc extinguishing wall. The first opening is formed in a wall portion which is on a side of the arc extinguishing wall toward which the first arc is extended and the second opening is formed in a wall portion which is on a side of the arc extinguishing wall toward which the second arc is extended.

### Advantageous Effects of Invention

With the electromagnetic contactor according to the present invention, it is possible to prevent a decrease in arc extinguishing performance even when a lot of metal vapor is generated at the time when heavy current is cut off.

### BRIEF DESCRIPTION OF DRAWINGS

FIG. 1 is a sectional view of an electromagnetic contactor according to a first embodiment of the present invention.

FIG. 2 is a perspective view illustrating the shape of an arc extinguishing wall constituting the electromagnetic contactor.

FIG. 3 is a perspective view illustrating a pair of arc extinguishing permanent magnets and a pair of magnetic pole plates attached to the arc extinguishing wall.

FIG. 4 is an arrow view taken along a line A-A in FIG. 1.

FIG. 5 is a sectional view of an electromagnetic contactor according to a second embodiment of the present invention.

### DESCRIPTION OF EMBODIMENTS

With reference to the drawings, the following describes embodiments of the present invention. In the drawings to be referred to in the following description, identical or similar portions have identical or similar reference signs. It is noted that the drawings are schematic, and a relationship between thickness and flat dimension, a ratio between layer thicknesses, and the like are different from real ones. Accordingly, a specific thickness or dimension should be determined in consideration of the following description. Further, it is needless to say that the drawings include portions having a different dimensional relationship or ratio.

Each embodiment describes a device or a method to embody the technical idea of the present invention, and the technical idea of the present invention does not specify the quality, shape, structure, arrangement, and the like of component parts to those described below. Various changes can be added to the technical idea of the present invention within a technical scope defined by claims described in Claims.

Note that terms indicating directions such as “up,” “down,” “left,” and “right” described in the following description are used by referring to directions in the attached drawings.

### First Embodiment

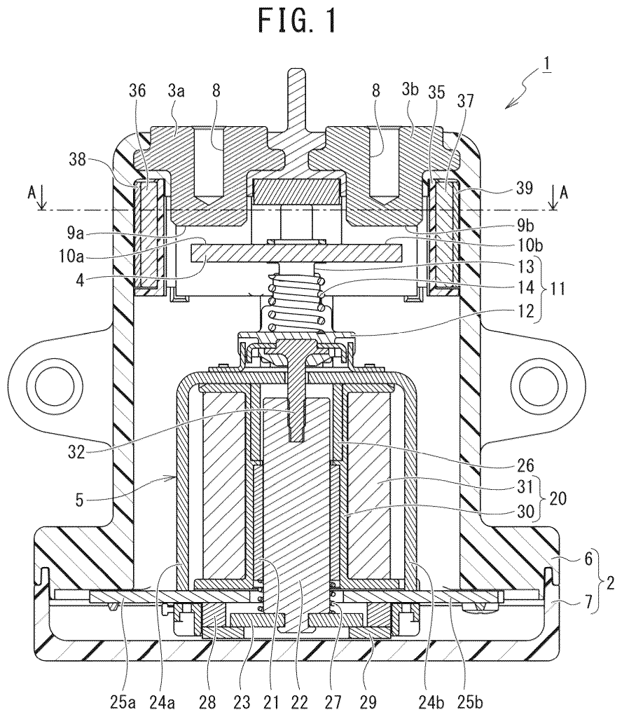

FIG. 1 illustrates an electromagnetic contactor 1 according to a first embodiment of the present invention.

The electromagnetic contactor 1 is an encapsulated high-voltage contactor for opening and closing a main circuit by use of electromagnetic force and includes an airtight container 2 made of resin and having electrical insulating properties, and a pair of fixed contacts 3, a movable contact 4, and an electromagnet unit 5 that are arranged in the airtight container 2. The electromagnet unit 5 drives the movable contact 4 to a direction along which the movable contact 4 comes into contact with and separates from the pair of fixed contacts 3.

The airtight container 2 is constituted by a case 6 and a cover 7, and arc extinguishing gas is enclosed inside the airtight container 2. It is noted that a housing according to the present invention corresponds to the airtight container 2.

The case 6 is a square tube-shaped member having an open lower end (one end) and a closed upper end (the other end) in FIG. 1. The cover 7 is a cover-shaped member. Respective open ends of the lower end of the case 6 and the cover 7 fit to each other to be joined by adhesive.

The pair of fixed contacts 3a and 3b are electrodes made of metal having conductivity and formed into a generally cylindrical shape. The pair of fixed contacts 3a, 3b are integrated by insert molding such that they pass through a wall portion of the case 6. Threaded holes 8 are formed in upper portions of the pair of fixed contacts 3a, 3b and are exposed outside the case 6. Terminal screws (not illustrated) on a primary side and a secondary side of the main circuit are engaged with the threaded holes 8. Respective lower portions of the pair of fixed contacts 3a and 3b project inside the case 6, and fixed contact points 9a and 9b are formed in the lower portions. It is noted that first and second fixed contact points according to the present invention correspond to the fixed contact points 9a and 9b.

The movable contact 4 is metal having conductivity and is formed in a flat-plate shape extending in the right-left direction in FIG. 1 such that the movable contact 4 is arranged to face the pair of fixed contacts 3. A pair of movable contact points 10a and 10b configured to come into contact with and separate from the fixed contact points 9a, 9b of the pair of fixed contacts 3a and 3b are formed in opposite ends of the movable contact 4 in the right-left direction.

The movable contact 4 is connected to the electromagnet unit 5 via a contact point support 11. The contact point support 11 includes a base 12 connected to the electromagnet unit 5, a pressing member 13 configured to hold the movable contact 4, and a contact spring 14 configured to apply a contact pressure to the movable contact 4. The contact spring 14 is a compression coiled spring and is provided between the base 12 and the movable contact 4 to bias the movable contact 4 upward in FIG. 1. When the contact spring 14 elastically supports the movable contact 4 as such, the contact pressure between the movable contact point 10a and 10b and the fixed contact point 9a and 9b is kept constant.

The electromagnet unit 5 includes a spool 20, a sliding collar 21, a movable plunger 22, an armature 23, a pair of outer yokes 24a and 24b, a pair of bottom yokes 25a and 25b, a plunger ring 26, a backspring 27, a permanent magnet 28, and an auxiliary yoke 29.

The spool 20 is a winding frame made of resin having electrical insulating properties, and a coil 31 is wound on a winding spindle 30 having a cylindrical shape and extending in the up-down direction.

The sliding collar 21 is formed in a cylindrical shape by use of resin having electrical insulating properties and is inserted into the winding spindle 30 from below in the up-down direction such that the sliding collar 21 fits in the winding spindle 30.

The movable plunger 22 is formed in a pillar shape extending in the up-down direction as a moving core and fits in the sliding collar 21 such that the movable plunger 22 is guided to advance or retreat along its axial direction. An upper portion of the movable plunger 53 in the up-down direction is connected to the base 12 of the contact point support 11 via a coupler 32. The armature 23 is a discoid yoke and is fixed to a lower end portion of the movable plunger 22.

The pair of outer yokes 24 are plate-shaped yokes and are fixed to the left side and the right side of the winding spindle 30. The pair of bottom yokes 25a and 25b are fixed to respective lower portions of the pair of outer yokes 24a and 24b such that the pair of bottom yokes 25a and 25b extend to the left side and the right side on the same extension line.

The plunger ring 26 is a cylindrical yoke extending in the up-down direction and is inserted into the winding spindle 30 from above in the up-down direction to fit therein such that the plunger ring 26 is fixed to upper pieces in respective upper portions of the pair of outer yokes 24 in the up-down direction. The plunger ring 26 has an inside diameter larger than the outside diameter of the movable plunger 22 and is set to keep a predetermined clearance relative to the movable plunger 22.

The backspring 27 is a compression coiled spring. The backspring 27 is passed through the movable plunger 22 in a state where the backspring 27 is sandwiched between the armature 23 and the sliding collar 21 and biases the movable plunger 22 downward in the up-down direction relative to the spool 20.

The permanent magnet 28 has a rectangular flat-plate shape having a round-hole. The permanent magnet 28 is arranged to make contact with respective lower portions of the pair of bottom yokes 25a, 25b and surround the armature 23. The auxiliary yoke 29 is a flat-shaped yoke and is attached to a lower portion of the permanent magnet 28.

The electromagnetic contactor of the present embodiment further includes an arc extinguishing wall 35 arranged to surround the pair of fixed contacts 3a and 3b and the movable contact 4. Further, a pair of arc extinguishing permanent magnets 36 and 37 and a pair of magnetic pole plates 38 and 39 are attached to the arc extinguishing wall 35.

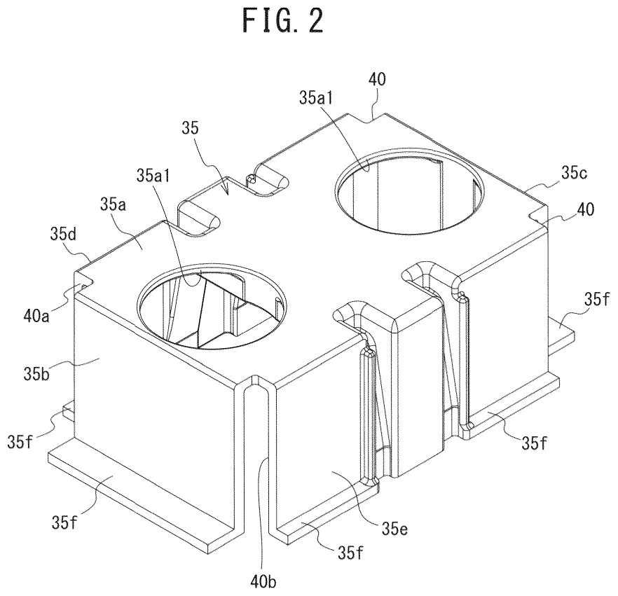

As illustrated in FIG. 2, the arc extinguishing wall 35 is a box-shaped body made of ceramics or made of synthetic resin. The arc extinguishing wall 35 includes a rectangular-plate-shaped cover 35a having a pair of contact holes 35al through which the pair of fixed contacts 3a and 3b are passed, short-side walls 35b and 35c and long-side walls 35d and 35e extending in the same direction from four edge portions of the cover 35a, and support plates 35f extending outwardly at right angles from respective ends of the short-side walls 35b and 35c and the long-side walls 35d and 35e. No corner portion is provided at an intersection between a short-side wall and a long-side wall adjacent to each other (e.g., the short-side wall 35b and the long-side wall 35e adjacent to each other), and four corner openings 40a to 40d are formed to linearly extend in the same direction as a direction where the short-side walls 35b, 35c and the long-side walls 35d and 35e extend. It is noted that a first opening in the present invention corresponds to the corner openings 40a and 40b, and a second opening in the present invention corresponds to the corner openings 40c and 40d.

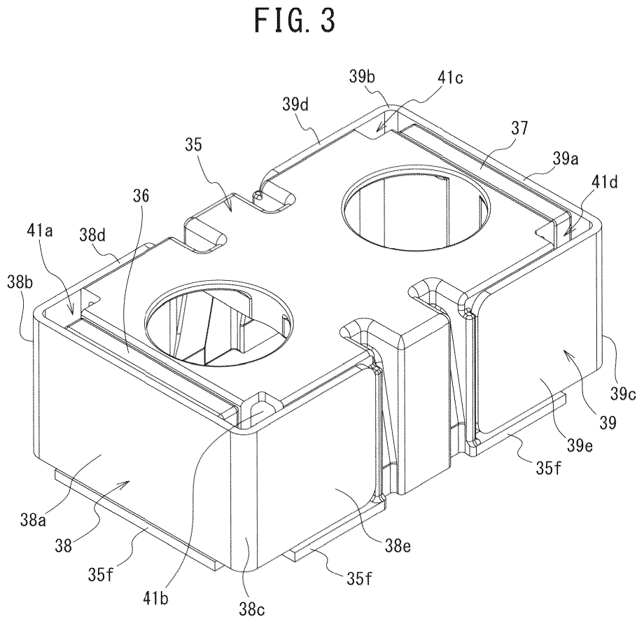

As illustrated in FIG. 3, the pair of arc extinguishing permanent magnets 36 and 37 are arranged on the support plate 35f to abut with the short-side walls 35b and 35c of the arc extinguishing wall 35.

As illustrated in FIG. 3, the magnetic pole plate 38 on one side is a member including a magnet abutment plate 38a, and a pair of parallel plate portions 38d and 38e extending parallel to each other via bending portions 38b and 38c from right and left sides of the magnet abutment plate 38a. As illustrated in FIG. 3, the magnetic pole plate 38 is arranged on the support plates 35f with the magnet abutment plate 38a abutting with the arc extinguishing permanent magnet 36 and with the pair of parallel plate portions 38d and 38e abutting with the long-side walls 35d and 35e of the arc extinguishing wall 35. The bending portions 38b and 38c of the magnetic pole plate 38 face the corner openings 40 of the arc extinguishing wall 35, so that outside communication spaces 41a and 41b are formed outside two corner openings 40a and 40b. Further, as illustrated in FIG. 3, the magnetic pole plate 39 on the other side is also a member including a magnet abutment plate 39a, and a pair of parallel plate portions 39d and 39e extending parallel to each other via bending portions 39b and 39c from right and left sides of the magnet abutment plate 39a. The magnetic pole plate 39 is also arranged on the support plates 35f with the magnet abutment plate 39a abutting with the arc extinguishing permanent magnet 37 arranged on the short-side wall 35c side of the arc extinguishing wall 35 and with the pair of parallel plate portions 39d and 39e abutting with the long-side walls 35d and 35e of the arc extinguishing wall 35. The bending portions 39b and 39c of the magnetic pole plate 39 face the corner openings 40 of the arc extinguishing wall 35, so that two outside communication spaces 41c and 41d are formed outside two corner openings 40c and 40d. It is noted that a first outside communication space according to the present invention corresponds to the outside communication spaces 41a and 41b, and a second outside communication space according to the present invention corresponds to the outside communication spaces 41c and 41d.

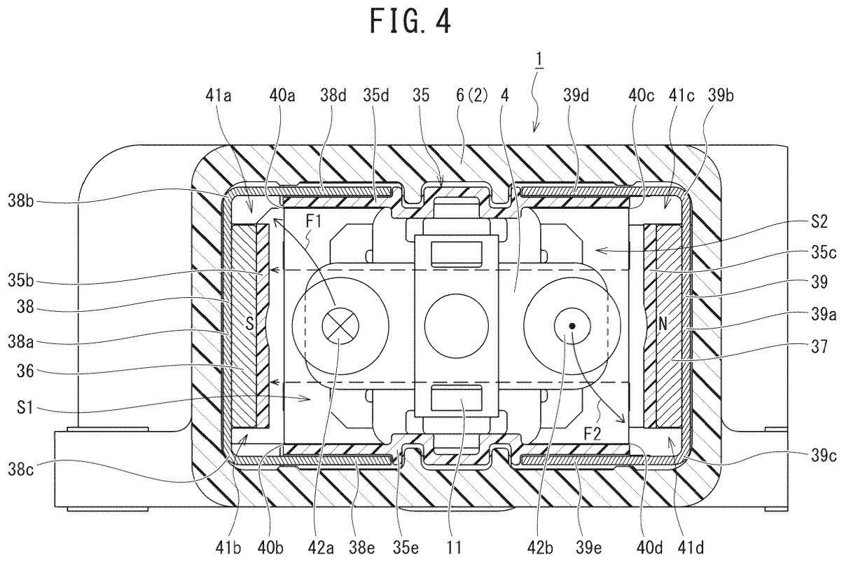

As illustrated in FIG. 4, the arc extinguishing wall 35 on which the pair of arc extinguishing permanent magnets 36 and 37 and the pair of magnetic pole plates 38 and 39 are arranged integrally is attached to the inner wall of the case 6 in a state where the arc extinguishing wall 35 surrounds the pair of the fixed contacts 3a and 3b and the movable contact 4.

A pole face of the arc extinguishing permanent magnet 36 which pole face abuts with the short-side wall 35b is S-pole, and a pole face of the arc extinguishing permanent magnet 37 which pole face abuts with the short-side wall 35c is N-pole.

The fixed contact point 9a of the fixed contact 3a on one side and the movable contact point 10a of the movable contact 4 which movable contact point 10 comes into contact with and separates from the fixed contact point 9a are referred to as a contact portion 42a. The fixed contact point 9b of the fixed contact 3b on the other side and the movable contact point 10b of the movable contact 4 which movable contact point 10b comes into contact with and separates from the fixed contact point 9b are referred to as a contact portion 42b. In this case, magnetic flux (dotted arrows in FIG. 4) flowing from the arc extinguishing permanent magnet 37 on one side to the arc extinguishing permanent magnet 36 on the other side crosses the contact portions 42a and 42b.

A space surrounded by the arc extinguishing wall 35 on the left side in FIG. 4 relative to the contact portion 42a is referred to as a first arc extinguishing space S1. A space surrounded by the arc extinguishing wall 35 on the right side in FIG. 4 relative to the contact portion 42b is referred to as a second arc extinguishing space S2. The first arc extinguishing space S1 and the second arc extinguishing space S2 communicate with four outside communication spaces 41a to 41d formed by the pair of magnetic pole plates 38 and 39 via four corner openings 40a to 40d formed in the arc extinguishing wall 35. The four outside communication spaces 41a to 41d communicate with a space where the electromagnet unit 5 is arranged in the airtight container 2 (the case 6).

Next will be described the operation of the electromagnetic contactor 1 of the present embodiment with reference to FIG. 4.

The electromagnetic contactor 1 of the present embodiment includes a positive (+) terminal connected to the fixed contact 3a on one side and a negative (−) terminal connected to the fixed contact 3b on the other side.

Here, assume a case where the coil 31 of the electromagnet unit 5 is in an unexcited state and in a released state where the electromagnet unit 5 does not generate exciting force to move the movable plunger 22 upward. In this released state, the movable plunger 22 is biased downward by the backspring 27, and the armature 23 adheres to the auxiliary yoke 29 due to the action of the permanent magnet 28. Accordingly, the movable contact 4 connected to the movable plunger 22 is distanced downward from the pair of fixed contacts 3a and 3b only by a predetermined distance. Accordingly, the current path between the pair of fixed contacts 3a and 3b is cut off, and the contact portions 42a and 42b are opened (an open state of the contact portions 42a, 42b).

When a current is applied to the coil 31 of the electromagnet unit 5 from the open state of the contact portions 42a and 42b, exciting force is generated in the electromagnet unit 5 to push the movable plunger 22 upward against attractive force from the permanent magnet 28 to the auxiliary yoke 29 and biasing force from the backspring 27, so that the armature 23 adheres to the bottom yokes 25a, 25b.

When the movable plunger 22 moves upward as such, the movable contact 4 connected to the movable plunger 22 also moves upward, and the movable contact points 10a, 10b of the movable contact 4 come into contact with the fixed contact points 9a and 9b of the pair of fixed contact 3a, 3b due to the contact pressure from the contact spring 14, so that the contact portions 42a, 42b are closed.

When heavy current flows into the main circuit from the closed state of the contact portions 42a and 42b and current application to the coil 31 of the electromagnet unit 5 is cut off, no exciting force to move the movable plunger 22 upward is generated in the electromagnet unit 5, so that the movable plunger 22 moves downward due to the biasing force from the backspring 27, and the armature 23 adheres to the auxiliary yoke 29 due to the action of the permanent magnet 28. When the movable plunger 22 moves downward, the movable contact 4 connected to the movable plunger 22 separates downward from the pair of fixed contacts 3a and 3b to enter an opening start state.

When heavy current flows into the main circuit to bring the contact portions 42a and 42b into the opening start state, a first arc is generated in the contact portion 42a, and a second arc is generated in the contact portion 42b, so that a current application state continues due to the first and second arcs. The current direction of the first arc is a direction from the fixed contact point 9a toward the movable contact point 10a, and the current direction of the second arc is a direction from the movable contact point 10b to the fixed contact point 9b.

At this time, the magnetic flux flowing from the N-pole of the arc extinguishing permanent magnet 37 to the S-pole of the arc extinguishing permanent magnet 36 crosses the first arc and the second arc. From the relationship between the current flow of the first arc and the magnetic flux, a Lorentz force F1 is generated toward the corner opening 40a of the arc extinguishing wall 35 on the top left side of the first arc extinguishing space S1 in FIG. 4 due to the Fleming's left-hand rule. Further, from the relationship between the current flow of the second arc and the magnetic flux, a Lorentz force F2 is generated toward the corner opening 40d of the arc extinguishing wall 35 on the bottom right side of the second arc extinguishing space S2 in FIG. 4 due to the Fleming's left-hand rule.

When the Lorentz force F1 is generated, the first arc is greatly extended toward the corner opening 40a of the arc extinguishing wall 35 on the top left side of the first arc extinguishing space S1 in FIG. 4 and is cooled off by contact with arc extinguishing gas. The first arc thus greatly extended is then cooled off by contact with the bending portion 38b of the magnetic pole plate 38 forming the outside communication space 41a through the corner opening 40a. When the Lorentz force F2 is generated, the second arc is greatly extended toward the corner opening 40d of the arc extinguishing wall 35 on the bottom right side of the second arc extinguishing space S2 and is cooled off by contact with arc extinguishing gas. The second arc thus greatly extended is then cooled off by contact with the bending portion 39c of the magnetic pole plate 39 forming the outside communication space 41d through the corner opening 40d.

When heavy current flows into the main circuit to bring the contact portions 42a, 42b into an open state, the fixed contact point 9a and the movable contact point 10a in the contact portion 42a melt due to a temperature rise in the first arc, so that a large amount of high-temperature metal vapor is generated. Further, the fixed contact point 9b and the movable contact point 10b in the contact portion 42b also melt due to a temperature rise in the second arc, so that a large amount of high-temperature metal vapor is generated.

The metal vapor generated in the contact portion 42a flows into the first arc extinguishing space S1. As illustrated in FIG. 4, the metal vapor passes through the outside communication spaces 41a and 41b from the corner openings 40a and 40b of the arc extinguishing wall 35 and flows to the space where the electromagnet unit 5 is arranged. Further, the metal vapor generated in the contact portion 42b flows into the second arc extinguishing space S2, and the metal vapor then passes through the outside communication spaces 41c and 41d from the corner openings 40c and 40d of the arc extinguishing wall 35 and flows to the space where the electromagnet unit 5 is arranged. The metal vapor flowing through the outside communication spaces 41a to 41d is cooled off by contact with the bending portions 38b and 38c and the bending portions 39b and 39c of the magnetic pole plates 38 and 39, the bending portions 38b and 38c and the bending portions 39b and 39c forming the outside communication spaces 41a to 41d.

Next will be described operation/working-effects of the electromagnetic contactor 1 of the present embodiment.

When the first arc is generated in the contact portion 42a at the time of cutting off the heavy current, the Lorentz force F1 is generated toward the corner opening 40a of the arc extinguishing wall in the first arc extinguishing space S1 due to the relationship between the current flow of the first arc and the magnetic flux, so that the first arc can be greatly extended. Further, when the second arc is generated in the contact portion 42b, the Lorentz force F2 is generated toward the corner opening 40d of the arc extinguishing wall 35 in the second arc extinguishing space S2 due to the relationship between the current flow of the second arc and the magnetic flux, so that the second arc can be also greatly extended.

Even when a large amount of high-temperature metal vapor is generated in the contact portions 42a and 42b at the time of cutting off the heavy current, the metal vapor generated in the contact portion 42a flows toward the outside communication spaces 41a and 41b via the corner openings 40a and 40b of the arc extinguishing wall 35 and then flows toward the space where the electromagnet unit 5 is arranged. Further, the metal vapor generated in the contact portion 42b also flows toward the outside communication spaces 41c and 41d via the corner openings 40c and 40d of the arc extinguishing wall 35 and then flows toward the space where the electromagnet unit 5 is arranged. Thus, the metal vapor thus generated in the contact portions 42a and 42b does not stay in the first arc extinguishing space S1 and the second arc extinguishing space S2, and no pressure rise occurs. Since the metal vapor causes air flows to directions toward the corner openings 40a and 40d of the arc extinguishing wall 35, the first arc and the second arc are further extended.

Accordingly, the first arc and the second arc are extended effectively along the air flows of the metal vapor, so that the cutoff performance can be improved.

Further, the first arc greatly extended is further cooled off by contact with the bending portion 38b of the magnetic pole plate 38 forming the outside communication space 41a through the corner opening 40a, and the second arc thus greatly extended is further cooled off by contact with the bending portion 39c of the magnetic pole plate 39 forming the outside communication space 41d through the corner opening 40d, so that the cutoff performance can be further improved.

Further, the metal vapor flowing to the outside communication spaces 41a and 41b from the corner openings 40a and 40b of the arc extinguishing wall 35 and the metal vapor flowing to the outside communication spaces 41c and 41d from the corner openings 40c and 40d of the arc extinguishing wall 35 are cooled off efficiently by contact with the bending portions 38b and 38c and the bending portions 39b and 39c of the magnetic pole plates 38 and 39, the bending portions 38b and 38c and the bending portions 39b and 39c forming the outside communication spaces 41a to 41d, so that the phase of the metal vapor changes to liquid or solid. Hereby, the pressure and the temperature in the airtight container 2 decrease in a short time, so that it is possible to prevent a decrease in arc extinguishing performance and to prevent the first arc and the second arc from being regenerated.

### Second Embodiment

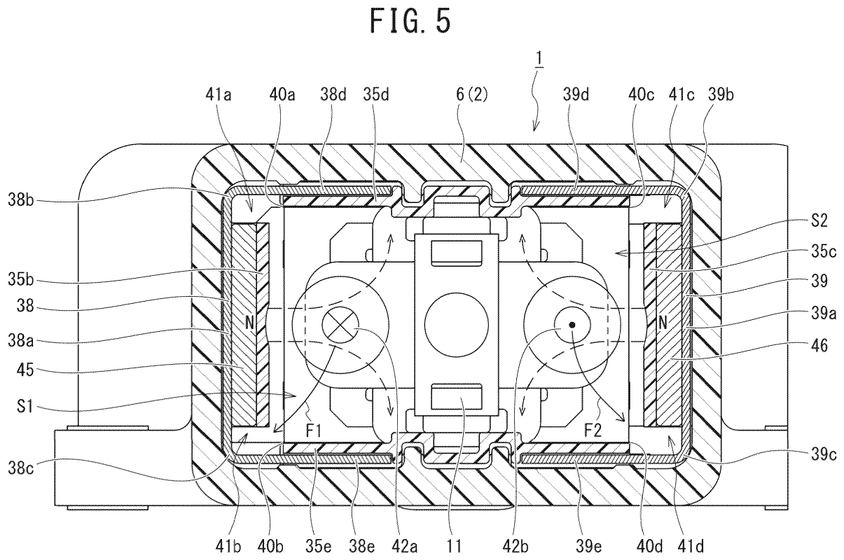

FIG. 5 illustrates an essential portion of the electromagnetic contactor 1 according to a second embodiment of the present invention. In the present embodiment, the electromagnetic contactor 1 includes a pair of arc extinguishing permanent magnets 45 and 46 having a configuration different from that of the pair of arc extinguishing permanent magnets 36 and 37 in the first embodiment. The other configurations are the same as those in the first embodiment, and they are referred to with the same reference signs as used in the first embodiment and are not described herein.

In the present embodiment, a pole face of the arc extinguishing permanent magnet 45 on one side which pole face abuts with the short-side wall 35b of the arc extinguishing wall 35 is N-pole, and a pole face of the arc extinguishing permanent magnet 46 on the other side which pole face abuts with the short-side wall 35c is N-pole.

As indicated by broken lines in FIG. 5, the arc extinguishing permanent magnet 45 on one side generates magnetic flux flowing from the short-side wall 35b of the arc extinguishing wall 35 to the long-side walls 35d and 35e, and the arc extinguishing permanent magnet 46 on the other side generates magnetic flux flowing from the short-side wall 35c of the arc extinguishing wall 35 to the long-side walls 35d, 35e.

In the electromagnetic contactor 1 of the present embodiment, when heavy current flows into the main circuit to bring the contact portions 42a, 42b into the opening start state, the first arc is generated in the contact portion 42a, and the second arc is generated in the contact portion 42b, so that the current application state continues due to the first arc and the second arc. The current direction of the first arc is a direction from the fixed contact point 9a toward the movable contact point 10a, and the current direction of the second arc is a direction from the movable contact point 10b to the fixed contact point 9b.

At this time, from the relationship between the current flow of the first arc and the magnetic flux of the arc extinguishing permanent magnet 45 on one side, a Lorentz force F1 is generated toward the corner opening 40b of the arc extinguishing wall 35 on the bottom left side in the first arc extinguishing space S1 due to the Fleming's left-hand rule. Further, from the relationship between the current flow of the second arc and the magnetic flux of the arc extinguishing permanent magnet 46 on the other side, a Lorentz force F2 is generated toward the corner opening 40d of the arc extinguishing wall 35 on the bottom right side of the second arc extinguishing space S2 due to the Fleming's left-hand rule.

When the Lorentz force F1 is generated, the first arc is greatly extended toward the corner opening 40b of the arc extinguishing wall 35 on the bottom left side of the first arc extinguishing space S1 and is cooled off by contact with arc extinguishing gas. The first arc thus greatly extended is then cooled off by contact with the bending portion 38c of the magnetic pole plate 38 forming the outside communication space 41b through the corner opening 40b. Further, when the Lorentz force F2 is generated, the second arc is greatly extended toward the corner opening 40d of the arc extinguishing wall 35 on the bottom right side of the second arc extinguishing space S2 and is cooled off by contact with arc extinguishing gas. The second arc thus greatly extended is then cooled off by contact with the bending portion 39c of the magnetic pole plate 39 forming the outside communication space 41d through the corner opening 40d.

Further, metal vapor generated in the contact portion 42a flows to the first arc extinguishing space S1, and the metal vapor passes through the outside communication spaces 41a and 41b from the corner openings 40a, 40b of the arc extinguishing wall 35 and flows toward the space where the electromagnet unit 5 is arranged. Further, metal vapor generated in the contact portion 42b flows into the second arc extinguishing space S2, and the metal vapor passes through the outside communication spaces 41c and 41d from the corner openings 40c and 40d of the arc extinguishing wall 35 and flows toward the space where the electromagnet unit 5 is arranged. The metal vapor flowing through the outside communication spaces 41a to 41d is cooled off by contact with the bending portions 38b and 38c and the bending portions 39b and 39c of the magnetic pole plates 38 and 39, the bending portions 38b and 38c and the bending portions 39b and 39c forming the outside communication spaces 41a to 41d.

In the electromagnetic contactor 1 of the present embodiment, when the first arc is generated in the contact portion 42a at the time of cutting off the heavy current, the Lorentz force F1 is generated toward the corner opening 40b of the arc extinguishing wall 35 in the first arc extinguishing space S1 due to the relationship between the current flow of the first arc and the magnetic flux of the arc extinguishing permanent magnet 45 on one side, so that the first arc can be greatly extended. Further, when the second arc is generated in the contact portion 42b, the Lorentz force F2 is generated toward the corner opening 40d of the arc extinguishing wall 35 in the second arc extinguishing space S2 due to the relationship between the current flow of the second arc and the magnetic flux, so that the second arc can be also greatly extended.

Even when a large amount of high-temperature metal vapor is generated in the contact portions 42a and 42b at the time of cutting off the heavy current, the metal vapor generated in the contact portion 42a flows toward the outside communication spaces 41a and 41b via the corner openings 40a and 40b of the arc extinguishing wall 35 and then flows toward the space where the electromagnet unit 5 is arranged. Further, the metal vapor generated in the contact portion 42b also flows toward the outside communication spaces 41c and 41d via the corner openings 40c and 40d of the arc extinguishing wall 35 and then flows toward the space where the electromagnet unit 5 is arranged. Thus, the first arc and the second arc are extended effectively along the air flows of the metal vapor, so that cutoff performance can be improved.

Similarly to the first embodiment, the first arc is further cooled off by contact with the bending portion 38c of the magnetic pole plate 38, and the second arc is also further cooled off by contact with the bending portion 39c of the magnetic pole plate 39, so that the cutoff performance can be further improved.

Further, similarly to the first embodiment, the metal vapor makes contact with the bending portions 38b and 38c and the bending portions 39b and 39c of the magnetic pole plates 38 and 39, the bending portions 38b and 38c and the bending portions 39b and 39c forming the outside communication spaces 41a to 41d, so that it is possible to prevent a decrease in arc extinguishing performance and to prevent the first arc and the second arc from being regenerated.

### REFERENCE SIGNS LIST

1 electromagnetic contactor
2 airtight container
3a, 3b fixed contact
4 movable contact
5 electromagnet unit
6 case
7 cover
8 threaded hole
9a, 9b fixed contact point
10a, 10b movable contact point
11 contact point support
12 base
13 pressing member
14 contact spring
20 spool
21 sliding collar
22 movable plunger
23 armature
24a, 24b outer yoke
25a, 25b bottom yoke
26 plunger ring
27 backspring
28 permanent magnet
29 auxiliary yoke
30 winding spindle
31 coil
32 coupler
35 arc extinguishing wall
35a cover
35al contact hole
35b, 35c short-side wall
35d, 35e long-side wall
35f support plate
36, 37, 45, 46 arc extinguishing permanent magnet
38, 39 magnetic pole plate
38a, 39a magnet abutment plate
38b, 38c, 39b, 39c bending portion
38d, 38e, 39d, 39e parallel plate portion
40a to 40d corner opening
41a to 41d outside communication space
42a, 42b contact portion
F1, F2 Lorentz force
S1 first arc extinguishing space
S2 second arc extinguishing space

1. An electromagnetic contactor comprising:
a pair of fixed contacts having first and second fixed contact points;
a movable contact having first and second movable contact points at opposite ends in a longitudinal direction of the movable contact, the first and second movable contact points being able to come into contact with and separate from the first and second fixed contact points;
an electromagnet unit configured to drive the movable contact;
a housing configured to house the pair of fixed contacts, the movable contact, and the electromagnet unit;
a box-shaped arc extinguishing wall having a first opening and a second opening and arranged in the housing so as to contain the pair of fixed contacts and the movable contact; and
a pair of arc extinguishing permanent magnets arranged to face each other and configured to extend a first arc generated between the first fixed contact point and the first movable contact point toward a first arc extinguishing space and to extend a second arc generated between the second fixed contact point and the second movable contact point toward a second arc extinguishing space, the first arc extinguishing space and the second arc extinguishing spaces being formed on one side and the other side of the movable contact in the longitudinal direction so as to be surrounded by the arc extinguishing wall,
wherein the first opening is formed in a wall portion which is on a side of the arc extinguishing wall toward which the first arc is extended and the second opening is formed in a wall portion which is on a side of the arc extinguishing wall toward which the second arc is extended.

2. The electromagnetic contactor according to claim 1, wherein
the arc extinguishing wall has a rectangular box shape, and
the first opening and the second opening are formed at corner portions of the arc extinguishing wall.

3. The electromagnetic contactor according to claim 1, wherein a first outside communication space communicating with the first arc extinguishing space via the first opening, and a second outside communication space communicating with the second arc extinguishing space via the second opening are formed outside the arc extinguishing wall.

4. The electromagnetic contactor according to claim 2, wherein a first outside communication space communicating with the first arc extinguishing space via the first opening, and a second outside communication space communicating with the second arc extinguishing space via the second opening are formed outside the arc extinguishing wall.

5. The electromagnetic contactor according to claim 3, wherein the first outside communication space and the second outside communication space are formed by magnetic pole plates arranged to surround the arc extinguishing wall from outside.

6. The electromagnetic contactor according to claim 4, wherein the first outside communication space and the second outside communication space are formed by magnetic pole plates arranged to surround the arc extinguishing wall from outside.

7. The electromagnetic contactor according to claim 5, wherein the first outside communication space and the second outside communication space operatively communicate with an internal space of the housing containing the electromagnet unit.

8. The electromagnetic contactor according to claim 6, wherein the first outside communication space and the second outside communication space operatively communicate with an internal space of the housing containing the electromagnet unit.

9. The electromagnetic contactor according to claim 1, wherein arc extinguishing gas is encapsulated inside the housing.

10. The electromagnetic contactor according to claim 2, wherein arc extinguishing gas is encapsulated inside the housing.
